(19) United States
(12) Patent Application Publication
(10) Pub. No.: US 2026/0241827 A1
(43) Pub. Date: Aug. 20, 2026

(54) CHARGING STATION FOR A PLURALITY OF ELECTRIC VEHICLES

(71) Applicant: SAGEMCOM ENERGY & TELECOM SAS, Bois-Colombes (FR)

(72) Inventors: Henri TEBOULLE, Bois-Colombes (FR); Ziv ROTER, Bois-Colombes (FR)

(73) Assignee: SAGEMCOM ENERGY & TELECOM SAS, Bois-Colombes (FR)

(21) Appl. No.: 19/538,707

(22) Filed: Feb. 12, 2026

(30) Foreign Application Priority Data
Feb. 20, 2025 (FR) 2501777

(51) Int. Cl. B60L 53/63; B60L 53/14; B60L 53/30; B60L 53/64

(52) U.S. Cl. CPC B60L 53/63; B60L 53/14; B60L 53/305; B60L 53/64

(57) ABSTRACT

An electric vehicle charging station makes it possible to charge a plurality of electric vehicles. The electric vehicle charging station including electronic circuitry configured to: obtain, from an upstream smart electricity meter, time ranges associated respectively with charging impact scores; interrogate the electric vehicles about their charge level and their charging current; obtain a user entry of a charging objective for each of the electric vehicles; calculate charging durations, for each electric vehicle, for each possible time range with regard to the charging objectives for the electric vehicles, so as to minimise a total charging impact score for the charging of the electric vehicles to achieve the charging objectives.

### TECHNICAL FIELD

The present invention relates to a charging station for a plurality of electric vehicles, and in particular the management of charging of said electric vehicles by the charging station.

### PRIOR ART

Electric vehicle charging stations (EVCSs) are known, in particular intended to be installed at home or in businesses.

The current electric vehicle charging stations EVCS have only one type-T2 socket and are therefore not able to charge a plurality of electric vehicles connected simultaneously.

The patent document EP 4 454 932 A1 is known, which discloses a system making it possible to charge two electric vehicles still at 100% via an external box emulating, seen from each of the two electric vehicles, a type-T2 interface. However, this system does not take account of the fact that the electrical network may suffer higher demands at certain moments and that it is desirable to avoid added demand on the electrical network.

### DISCLOSURE OF THE INVENTION

A method is proposed here for managing charging of a plurality of electric vehicles implemented by an electric vehicle charging station connected downstream of a smart electricity meter, the electric vehicle charging station comprising:
an interface for communicating with the smart electricity meter;
an interface for communicating with the electric vehicles;
a man-machine interface;
   the method being such that the electric vehicle charging station performs the following steps:
obtaining, from the smart electricity meter, time ranges associated respectively with charging impact scores, each charging impact score representing an electricity-consumption impact during the time range in question;
identifying the electric vehicles connected;
interrogating the charge level and the charging current of the electric vehicles identified;
obtaining a user entry, via the man-machine interface, of a charging objective for each of the electric vehicles identified, the charging objective representing a charge level to be achieved at a target time;
obtaining a current time;
calculating a required total charging duration, for each electric vehicle identified, to achieve the charge level to be achieved and the charging current of the electric vehicle in question;
eliminating, for each electric vehicle identified, each time range that is inapplicable according to the current time and the target time for the electric vehicle in question;
calculating charging durations, for each electric vehicle identified, for each time range remaining, so as to minimise a total charging impact score for charging the electric vehicles identified to achieve the charging objectives;
controlling the charging of the electric vehicles according to a schedule defined by said charging duration calculations.

Thus, by taking account of the charging impact score associated with the time ranges in the scheduling of the charging of said plurality of electric vehicles, the added demands on the electric vehicle are avoided while complying with the charging objectives defined for each of the electric vehicles.

According to a particular embodiment, the electric vehicle charging station obtains information indicating whether simultaneous chargings are enabled or not, and said charging duration calculations, for each electric vehicle identified, for each remaining time range, take account of the information indicating whether simultaneous chargings are enabled or not.

According to a particular embodiment, the information indicating whether simultaneous chargings are enabled or not is obtained by user entry via the man-machine interface.

According to a particular embodiment, when simultaneous chargings are enabled, the electric vehicle charging station performs the following steps:
calculating firstly the charging durations, for each time range and for each electric vehicle identified, avoiding the simultaneous charging of said electric vehicles;
if the charging objectives can thus be achieved, and if the resulting total charging impact score is suitable for the user, charging the electric vehicles without overlap of their charging periods;
otherwise calculating the charging durations, for each time range and for each electric vehicle identified, enabling the simultaneous charging of said electric vehicles.

According to a particular embodiment, for non-enabled simultaneous chargings, the electric vehicle charging station calculates the charging durations XiTj, for each electric vehicle i, and for each time range Tj, taking account of the fact that the sum of the charging durations XiTj, with i=1, . . . , n, for any j=1, . . . , m, does not exceed the duration DTj of the time range Tj in question, i.e.:

$${\sum }_{i = 1}^{n} XiTj \leq DTj , \qquad for any j = 1 , … , m$$

by maximising the following expression, for each time range Tj, taking the time ranges in their increasing order of charging impact score STj:

$${\sum }_{i = 1}^{n} ( XiTj \times Ii )$$

with XiTj≤min(XiTjₘₐₓ, Di) without overlap of the charging periods,
where Ii represents the charging current of the electric vehicle i,
where XiTjₘₐₓ; is the maximum charging duration for the electric vehicle i during the time range Tj, with XiTjₘₐₓ=0 for each time range that is inapplicable for the electric vehicle i, and if not XiTjₘₐₓ=min(Di; DTj) otherwise,
and where Di is said total charging duration required for the electric vehicle i.

According to a particular embodiment, for non-enabled simultaneous chargings, the electric vehicle charging station calculates the charging durations XiTj, for each electric vehicle i, and for each time range Tj, taking account of the fact that the sum of the charging durations XiTj, with i=1, . . . , n, for any j=1, . . . , m, does not exceed the duration DTj of the time range Tj in question, i.e.:

$${\sum }_{i = 1}^{n} XiTj \leq DTj , \qquad for any j = 1 , … , m$$

by maximising the following expression, for each time range Tj, taking the time ranges in their increasing order of charging impact score STj:

$${\sum }_{i = 1}^{n} ( XiTj \times Ii )$$

with XiTj≤min(XiTjₘₐₓ; Di) without overlap of the charging periods,
where Ii represents the charging current of the electric vehicle i,
where XiTjₘₐₓ is the maximum charging duration for the electric vehicle i during the time range Tj, with XiTjₘₐₓ=0 for each time range that is inapplicable for the electric vehicle i, and if not XiTjₘₐₓ=min (Di; DTj) otherwise,
where Di is said total charging duration required for the electric vehicle i.
and where DTj_i is the maximum duration in the time range Tj during which the electric vehicle i can be charged.

According to a particular embodiment, for enabled simultaneous chargings, the electric vehicle charging station calculates the charging durations XiTj, for each electric vehicle i, so that

$$XiTj = min ( {XiTj}_{max ;} D i {\sum }_{k ∖ S T k < STj} XiTk )$$

where XiTjₘₐₓ is the maximum charging duration for the electric vehicle i during the time range Tj, with XiTjₘₐₓ=0 for each time range that is inapplicable for the electric vehicle i, and if not XiTjₘₐₓ=min (Di; DTj) otherwise,
where DTj is the duration of the time range Tj and Di is said total charging duration required for the electric vehicle i.
and where k\STK<STj signifies k such that STk<STj, where STj represents the charging impact score associated with the time range Tj.

According to a particular embodiment, for enabled simultaneous chargings, the electric vehicle charging station (122) calculates the charging durations XiTj, for each electric vehicle i, so that

$$XiTj = min ( {XiTj}_{max ;} Di {\sum }_{k ∖ STk < STj} XiTk )$$

where XiTjₘₐₓ is the maximum charging duration for the electric vehicle i during the time range Tj, with XiTjₘₐₓ=0 for each time range that is inapplicable for the electric vehicle i, and if not XiTjₘₐₓ=min (Di; DTj) otherwise,
where Di is said total charging duration required for the electric vehicle i,
where DTj_i is the maximum duration in the time range Tj during which the electric vehicle i can be charged, and where k\STK<STj signifies k such that STK<STj, where STj represents the charging impact score associated with the time range Tj.

According to a particular embodiment, the electric vehicle charging station comprising a shunt on each phase intended to electrically supply an electrical connector to which a said electric vehicle is connected, the electric vehicle charging station ensures, by measuring electrical consumption by means of the shunt, that the charging of the electric vehicle concerned is actually under way when charging is required and gives a user alarm in the contrary case.

A computer program is also proposed here, which can be stored on a medium and/or be downloaded from a communication network, in order to be read by a processor. This computer program comprises instructions for implementing the method mentioned above in any one of the embodiments thereof, when said instructions are executed by a processor. The invention also relates to an information storage medium storing such instructions causing the execution, by the processor, of the method mentioned above according to any one of the embodiments thereof, when said instructions are read (from the storage medium and executed by the processor).

An electric vehicle charging station is also proposed here, which is configured to charge a plurality of electric vehicles and is intended to be connected downstream of a smart electricity meter, the electric vehicle charging station comprising:
an interface for communicating with the smart electricity meter;
an interface for communicating with the electric vehicles;
a man-machine interface; the electric vehicle charging station comprising electronic circuitry configured to perform the following steps:
obtaining, from the smart electricity meter, time ranges associated respectively with charging impact scores, each charging impact score representing an electricity-consumption impact during the time range in question;
identifying the electric vehicles connected;
interrogating the charge level and the charging current of the electric vehicles identified;
obtaining a user entry, via the man-machine interface, of a charging objective for each of the electric vehicles identified, the charging objective representing a charge level to be achieved at a target time;
obtaining a current time;
calculating a required total charging duration, for each electric vehicle identified, to achieve the charge level to be achieved and the charging current of the electric vehicle in question;
eliminating, for each electric vehicle identified, each time range that is inapplicable according to the current time and the target time for the electric vehicle in question;
calculating charging durations, for each electric vehicle identified, for each time range remaining, so as to minimise a total charging impact score for charging the electric vehicles identified to achieve the charging objectives;
controlling the charging of the electric vehicles according to a schedule defined by said charging duration calculations.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically an automated smart electricity meter management system in which the present invention can be implemented;

FIG. 2 illustrates schematically an algorithm for managing charging of a plurality of electric vehicles;

FIG. 3 illustrates schematically an algorithm for charging a plurality of electric vehicles, as scheduled in application of the algorithm in FIG. 2; and

FIG. 4 illustrates schematically an example of a hardware platform for implementing, in the form of electronic circuitry, an electric vehicle charging station controller.

### DETAILED DISCLOSURE OF EMBODIMENTS

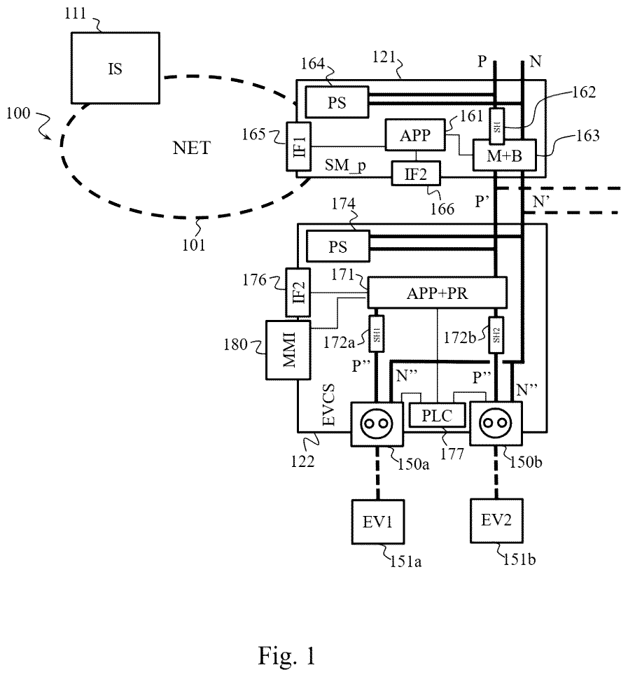

FIG. 1 illustrates schematically a system 100 for the automated management of smart electricity meters 121 in which the present invention can be implemented.

The automated management system 100 is configured to make a collection of electricity consumption data resulting from measurements made by smart electricity meters 121.

Each smart electricity meter SM 121 supervises the electricity distribution for an electrical installation to which an electric vehicle charging station EVCS 122 is potentially connected, downstream of the smart electricity meter SM 121 with respect to the electricity network.

The electric vehicle charging station EVCS 122 is configured for charging electric vehicles EV1 151a, EV2 151b, connected in parallel to each other, to the electric vehicle charging station EVCS 122. As detailed hereinafter, the electric vehicle charging station EVCS 122 is configured either to simultaneously charge the electric vehicles EV1 151a, EV2 151b, or to sequentially charge the electric vehicles EV1 151a, EV2 151b, or preferentially to make it possible, via a user interface, to choose to charge the electric vehicles EV1 151a, EV2 151b simultaneously or sequentially.

The smart electricity meters SM 121 are managed remotely by an information system IS 111. The remote management of the smart electricity meters SM 121 by the information system IS 111, and in particular the reading of electricity consumption information, takes place through a communication network NET 101. To do this, each smart electricity meter SM 121 has a communication interface IF1 165 adapted and configured to communicate via the communication network NET 101. For example, the communication network NET 101 is a wireless communication network of the 5G (5th Generation) type. According to other examples, the communication network NET 101 is a wireless communication network of the following types: GPRS (“General Packet Radio Service”), UMTS (“Universal Mobile Telecommunication System”), LTE-MTC (“Long-Term Evolution Machine Type Communication”), also known by the diminutive LTE-M, or NB-IoT (“NarrowBand Internet of Things”). According to yet another example, the communication network NET 101 is a powerline communication PLC network, for example conforming to the PRIME or G3-PLC standard.

Each electrical installation is associated with a subscription that defines conditions for electricity distribution to said electrical installation, for example authorised power limits or specific conditions for electricity distribution in predetermined time ranges.

In one and the same electrical installation at a subscriber, the smart electricity meter SM 121 is installed in advance, typically by an agent of a first electricity supplier, directly at the Phase P/Neutral N electrical incoming cable on the electrical network side, and the electric vehicle charging station EVCS 122 is installed subsequently, on a Phase P′/Neutral N′ electricity supply at the output of the smart electricity meter SM 121, which typically also supplies other electrical devices of the electrical installation. The electric vehicle charging station EVCS 122 is typically installed at a distance from the smart electricity meter SM 121 that makes it possible to put in communication the smart electricity meter SM 121 and the electric vehicle charging station EVCS 122 by means of respective communication interfaces IF2 166, 176. Since the smart electricity meter SM 121 and the electric vehicle charging station EVCS 122 are typically installed in proximity to each other, the communication interfaces IF2 166, 176 are adapted and configured to establish a short-range communication link, for example in accordance with the M-Bus (“Meter Bus”) remote-reading specifications as defined in EN 13757-2 or in accordance with the wM-Bus (“Wireless M-Bus”) specifications as defined in EN 13757-4. Other short-range communication technologies can be used, such as Bluetooth, Wi-Fi, Zigbee, KNX, KNX-RF, RS485 etc. Pairing between the smart electricity meter SM 121 and the electric vehicle charging station EVCS 122 is preferentially implemented at the time of commissioning of the electric vehicle charging station EVCS 122.

Each smart electricity meter SM 121 comprises an internal power supply device PS 164 used for electrically supplying, from the Phase P and Neutral N, elements internal to the secondary smart electricity meter SM 121. Apart from the communication interface IF1 165 and the communication interface IF2 166, these internal elements of the smart electricity meter SM 121 include an application function APP 161, for example executed by a processor provided with a memory or implemented by a dedicated electronic component, configured to control the smart electricity meter SM 121, in particular in the context of reading electricity consumption information. The internal elements of the smart electricity meter SM 121 furthermore include a metrology function equipped with a breaker 163 (denoted M+B in FIG. 1) that makes measurements of electricity consumption of the electrical installation supervised by the smart electricity meter SM 121 in question. The breaker of the smart electricity meter SM 121 enables the information system IS 111 to selectively enable or inhibit the electrical supply to the electrical installation supervised by the smart electricity meter SM 121.

The electricity consumption of the electrical installation is measured by means of a shunt S 162 installed at the input of the smart electricity meter SM 121 (Phase P, after the power connector of the internal power supply device PS 164 of said smart electricity meter SM 121), and voltage measurements at its terminals make it possible to obtain a precise and authenticated indication of the electricity consumption of the electrical installation. At the output of the electric vehicle charging station EVCS 122, an electrical supply Phase P″/Neutral N″ makes it possible to electrically supply the electric vehicles EV1 151a, EV2 151b by means of respective electrical connectors 150a, 150b. The electrical connectors 150a, 150b thus make it possible to simultaneously connect a plurality of electric vehicles EV1 151a, EV2 151b.

In a particular embodiment, the electrical connectors 150a, 150b are T2-type sockets. In FIG. 1, two electrical connectors 150a, 150b are shown for illustration; the electric vehicle charging station EVCS 122 may however comprise a larger number of electrical connectors to make it possible to connect a larger number of electric vehicles.

It should be noted that the smart electricity meter SM 121 may be a polyphase meter and the electric vehicle charging station EVCS 122 be supplied by only one of the electrical supply phases provided by the smart electricity meter SM 121. In a variant, the electric vehicle charging station EVCS 122 may be supplied by a plurality of electrical supply phases provided by the smart electricity meter SM 121 in order to make it possible to charge electric vehicles on different phases.

The electric vehicle charging station EVCS 122 comprises an internal power supply device PS 174 used for electrically supplying, from the Phase P′ and Neutral N′, elements internal to the electric vehicle charging station EVCS 122. Apart from the communication interface IF2 176, these internal elements of the electric vehicle charging station EVCS 122 include an application and power-relay function (denoted APP+PR in FIG. 1) 171, implemented by a controller and configured to control the electric vehicle charging station EVCS 122 and the selective charging of the electric vehicles EV1 151a, EV2 151b.

The electric vehicle charging station EVCS 122 comprises an interface for communication with the electric vehicles EV1 151a, EV2 151b. Preferentially, this communication interface is of the powerline communication PLC type 177. In a particular embodiment, this communication interface is of the powerline communication PLC type 177 and is adapted so that the electric vehicle charging station EVCS 122 dialogues with the electric vehicles EV1 151a, EV2 151b via the CP pin of the T2 sockets in accordance with IEC 15118-2. In which case, the electric vehicles EV1 151a, EV2 151b also have the ability to dialogue via the CP pin of the T2 socket.

This communication interface 177 enables the electric vehicle charging station EVCS 122 to recover, from the electric vehicles EV1 151a, EV2 151b, information representing a present charge level and charging current, such as charging-capacity information (e.g. in W.h), for charging necessary for reaching the full charge capacity (e.g. in W.h), etc.

The electric vehicle charging station EVCS 122 comprises a man-machine interface MMI 180 enabling a user to enter information, such as charging objectives, and to display for the user information such as a charging impact score.

In a particular embodiment, the electric vehicle charging station EVCS 122 comprises, on each phase P″ intended to electrically supply a said electrical connector 150a, 150b, a respective shunt SH1 172a, SH2 172b. Voltage measurements at their terminals make it possible to obtain a precise and authenticated indication of the electrical consumption of the charging of the electric vehicle EV1 151a, EV2 151b concerned. This enables the electric vehicle charging station EVCS 122 to ensure that the charging of the electric vehicle EV1 151a, EV2 151b concerned is actually under way when this is required and to give a user alarm in the contrary case.

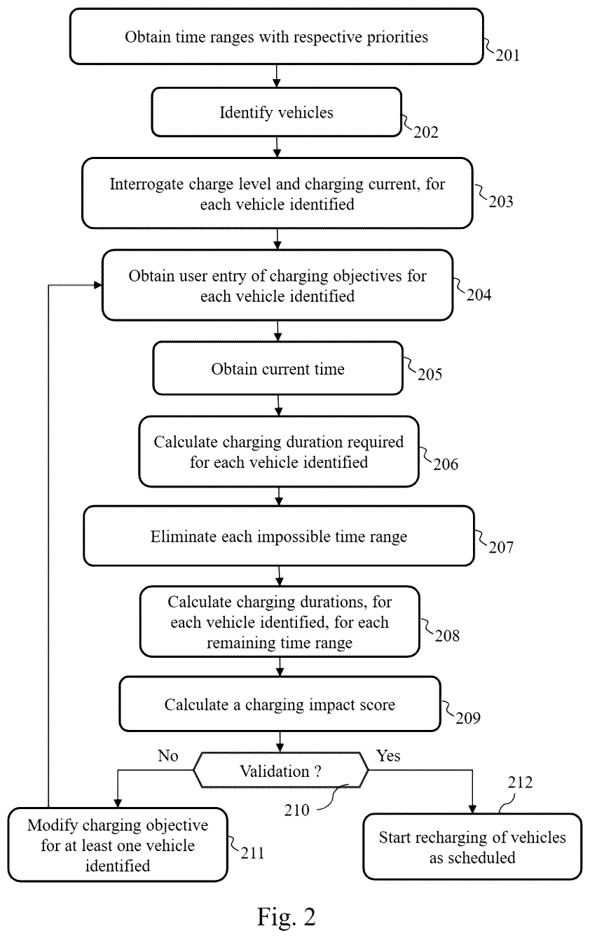

The application and power-relay function APP+PR 171 is configured to manage the charging of the electric vehicles EV1 151a, EV2 151b according to charging objectives indicated via the man-machine interface MMI 180 and taking account of time-range use priorities. This aspect is detailed below in relation to FIG. 2.

FIG. 2 illustrates schematically an algorithm for managing charging of a plurality of electric vehicles.

In a step 201, the electric vehicle charging station EVCS 122 obtains information representing time ranges with respective priorities. In other words, the time is broken down into time ranges (Tj with j=1, . . . , m for m time ranges in total with respective durations DTj) and each of these time ranges with an associated priority Pj. The priority Pj of each time range Tj(j=1, . . . , m) is associated with a charging impact score STj. The higher the priority, the lower the charging impact score; and the lower the priority, the higher the charging impact score. The charging impact score STj represents an amplitude of impact of an electrical consumption during the time range Tj in question, typically on the electrical network or simply on the electrical installation. The electric vehicle charging station EVCS 122 will therefore seek to implement as a priority chargings of electric vehicles in time ranges Tj with a lower charging impact score STj.

For example, four time ranges T1 (from 10 PM to 7 AM), T2 (from 10 AM to 6 PM), T3 (from 7 AM to 10 AM) and T4 (from 6 PM to 10 PM) are defined with respective charging impact scores ST1, ST2, ST3 and ST4 such that ST1<ST2<ST3<ST4 (involving respective priorities P1, P2, P3 and P4 such that P1>P2>P3>P4).

In a step 202, the electric vehicle charging station EVCS 122 identifies the electric vehicles EV1 151a, EV2 151b connected to the electrical connectors 150a, 150b (n>1 electric vehicles connected). The electric vehicle charging station EVCS 122 uses the communication interface 177 for interrogating the electric vehicles EV1 151a, EV2 151b actually connected to the electrical connectors 150a, 150b.

In a step 203, the electric vehicle charging station EVCS 122 interrogates each of the electric vehicles EV1 151a, EV2 151b with regard to their respective charge level (Ci_{INIT}, with i=1, . . . , n) and their respective charging current (Ii, with i=1, . . . , n).

In a step 204, the electric vehicle charging station EVCS 122 obtains, via the man-machine interface MMI 180, a user entry of charging objectives for each electric vehicle EV1 151a, EV2 151b. The charging objectives represent a charge-level objective to be achieved Ci_{FINAL} (avec i=1, . . . , n) at a target time Hi (with i=1, . . . , n), for each electric vehicle identified.

In a step 205, the electric vehicle charging station EVCS 122 obtains current-time information Hc. For example, the electric vehicle charging station EVCS 122 is equipped with an internal clock. In another example, the electric vehicle charging station EVCS 122 interrogates the smart electricity meter SM 121, which has an internal clock, in order to know the current time whenever necessary.

In a step 206, the electric vehicle charging station EVCS 122 calculates the required charging duration Di, for each electric vehiclei (i=1, . . . , n), in order to achieve the charging objectives for said electric vehicle i in question. The required charging duration Di is calculated as follows:

$$D i = \frac{C {i}_{FINAL} - C {i}_{INIT}}{U \times Ii}$$

where Uis the mains voltage of the electrical supply of the electrical installation (e.g. 230 V in Europe and 110 V in the United States of America.

In a step 207, the electric vehicle charging station EVCS 122 eliminates, for each electric vehicle i (i=1, . . . , n), any time range inapplicable with regard to the current time Hc and the target time Hi specified in the charging objectives for the electric vehicle i in question. For example, considering the aforementioned time ranges T1, T2, T3 and T4, and furthermore considering that it is 8 PM and the target time specified in the charging objectives of all the electric vehicles EV1 151a, EV2 151b is 8 AM, then the time range T2 (from 10 AM to 6 PM) is impossible to use and is eliminated from the charging management with a view to achieving the charging objectives fixed by the user.

Thus, if no charging is possible for the electric vehicle i during the time range Tj, then the maximum charging duration for the electric vehicle i during the time range Tj is XiTjₘₐₓ=0, and otherwise XiTjₘₐₓ=min (Di, DTj),

In a variant, DTj in the above equality can be replaced by DTj_i (with DTj_i≤DTj), where DTj_i is the maximum duration in the time range Tj during which the electric vehicle i can be charged, taking account of the fact that it is possible that the electric vehicle i may not be able to benefit from the entire duration DTj of the time range Tj to be charged therein since the electric vehicle i will perhaps be disconnected from the electric vehicle charging station EVCS 122 during part of the associated period Tj, related to the period of presence of said electric vehicle i at the home of the subscriber during said period Tj. In particular, DTj_i is equal to the remaining duration of the time range Tj beyond the current time Hc, when the current time Hc is included in the time range Tj. In particular also, DTj_i is equal to the amount of time between the start of the time range Tj and the target time Hi in the charging objectives for the electric vehicle i in question, when said target time Hi is included in the time range Tj.

In a step 208, the electric vehicle charging station EVCS 122 makes calculations of charging durations, for each electric vehicle EV1 151a, EV2 151b, for each remaining time range (i.e. any time range for which XiTjₘₐₓ≠0), taking account of the charging objectives for each electric vehicle EV1 151a, EV2 151b.

The calculations of charging durations take account of the possibility, or not, of simultaneously charging the electric vehicles EV1 151a, EV2 151b. Information indicating whether simultaneous chargings are enabled or not can be configured, in the factory or at installation, in the electric vehicle charging station EVCS 122. The electric vehicle charging station EVCS 122 can also in a variant obtain this information from the smart electricity meter SM 121, for example on configuration of the information system IS 111 according to the subscription taken out. In yet another variant, this information may be obtained by user selection by virtue of an entry via the man-machine interface MMI 180.

If the simultaneous charging of electric vehicles is not enabled, the electric vehicle charging station EVCS 122 calculates the charging durations XiTj, for each electric vehicle i, and for each time range Tj, taking account of the fact that the sum of the charging durations XiTj, with i=1, . . . , n, for any j=1, . . . , m, does not exceed the duration DTj of the time range Tj in question, i.e.:

$${\sum }_{i = 1}^{n} XiTj \leq DTj , for any j = 1 , … , m$$

Taking account of this constraint, the electric vehicle charging station EVCS 122 calculates a set of charging durations XiTj, for each electric vehicle i, and for each time range Tj, which makes it possible to minimise a total charging impact score Stot, such that:

$$Stot = {\sum }_{j = 1}^{m} ( ( {\sum }_{i = 1}^{n} ( XiTj \times Ii ) ) \times STj )$$

by maximising the following expression, for each time range Tj, taking the time ranges in their decreasing order of priority Pj (or, in an equivalent manner, their increasing order of charging impact score STj):

$${\sum }_{i = 1}^{n} ( XiTj \times Ii )$$

with XiTj≤min (XiTjₘₐₓ, Di) without overlap of the charging periods.

For example, a linear programming algorithm, such as the Simplex Algorithm, can be used to do this.

If the simultaneous charging of electric vehicles is enabled, the electric vehicle charging station EVCS 122 calculates the charging durations XiTj, for each electric vehicle i, and for each time range Tj, taking account of the fact that each charging duration XiTj, with i=1, . . . , n, for any j=1, . . . , m, does not exceed the duration DTj of the time range Tj in question.

Taking account of this constraint, the electric vehicle charging station EVCS 122 calculates a set of charging durations XiTj, for each electric vehicle i, and for each time range Tj, which makes it possible to minimise the aforementioned total charging impact score Stot.

In a particular embodiment, the electric vehicle charging station EVCS 122 calculates the charging durations XiTj, for each electric vehicle i, so that

$$XiTj = min ( {XiTj}_{max ;} D i {\sum }_{k ∖ Pk > Pj} XiTk )$$

where k\Pk>Pj signifies k such that Pk>Pj,
or in an equivalent manner:

$$XiTj = min ( {XiTj}_{max ;} D i - {\sum }_{k ∖ STk < STj} XiTk )$$

where k\STK<STj signifies k such that STK<STj.

In a step 209, the electric vehicle charging station EVCS 122 calculates the total charging impact score Stot and presents it to the user via the man-machine interface MMI 180.

In a step 210, the electric vehicle charging station EVCS 122 awaits a validation, or a rejection, by means of the man-machine interface MMI 180. When validation is received, a step 212 is performed; otherwise, when rejection is received, a step 211 is performed.

In the step 211, the electric vehicle charging station EVCS 122 awaits new charging objectives, so as to reiterate the steps 204 to 210 with these new charging objectives. The user can for example lower the charging level Ci_{FINAL} expected for such and such an electric vehicle i.

In the step 212, the electric vehicle charging station EVCS 122 demands the charging of the electric vehicles EV1 151a, EV2 151b in accordance with a schedule that complies with the calculations and constraints established at the step 208.

In a particular embodiment, although simultaneous charging of the electric vehicles is enabled, the electric vehicle charging station EVCS 122 firstly calculates the charging durations, for each time range Tj and for each electric vehicle i (i=1, . . . , n), avoiding simultaneous charging of said electric vehicles. If the charging objectives can thus be achieved, and if the resulting total charging impact score Stot is suitable for the user, this gives rise to the validation of the corresponding schedule and the electric vehicles are thus charged without overlap of their charging periods. This makes it possible to limit the amplitude of the demands on the electrical installation and, generally, on the electrical supply network. Otherwise, if the charging objectives cannot be achieved without enabling simultaneous charging of the electric vehicles, or if the resulting total charging impact score Stot does not suit the user, this gives rise to the rejection of the corresponding schedule and the electric vehicle charging station EVCS 122 then calculates charging durations, for each time range Tj and for each electric vehicle i (i=1, . . . , n), enabling simultaneous charging of said electric vehicles.

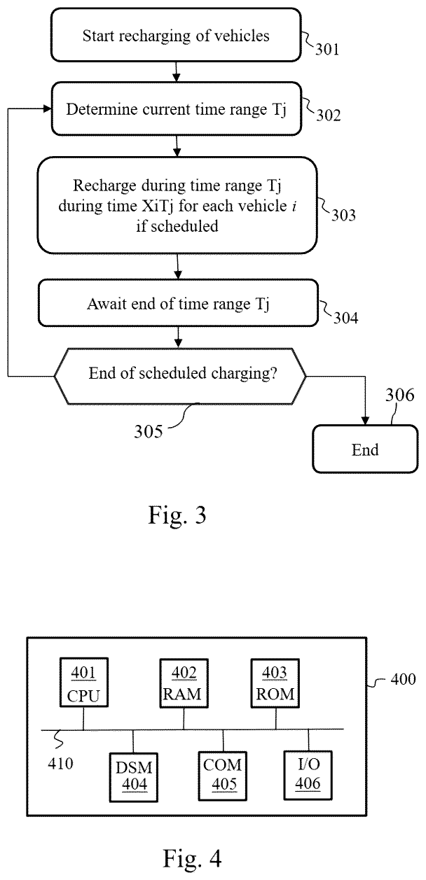

FIG. 3 illustrates schematically an algorithm for charging a plurality of electric vehicles, as scheduled in application of the algorithm in FIG. 2.

In a step 301, the electric vehicle charging station EVCS 122 initiates the charging of a plurality of vehicles following the execution of the algorithm in FIG. 2. A schedule was therefore established according to charging objectives and time ranges Tj (j=1, . . . , m), for each electric vehicle i (i=1, . . . , n).

In a step 302, the electric vehicle charging station EVCS 122 determines which is the current time range Tj.

In a step 303, the electric vehicle charging station EVCS 122 charges during the time range Tj, during the period XiTj, for each vehicle i that was scheduled for charging during said time range Tj. As already indicated, chargings of a plurality of electric vehicles during the time range Tj can be implemented sequentially or simultaneously (charging overlap period), in accordance with the schedule established.

When in one and the same time range a plurality of electric vehicles are scheduled to be charged sequentially, the electric vehicle charging station EVCS 122 can charge a first electric vehicle i until the corresponding period XiTj has elapsed before passing to the charging of another electric vehicle i′(i′=1, . . . , n with i′≠i) until the corresponding period Xi′Tj has elapsed.

In a variant, the electric vehicle charging stations EVCS 122 can recharge the electric vehicles i and i′ in alternation until the periods XiTj and Xi′Tj respectively have elapsed. This enables each of the electric vehicles i and i′ to benefit progressively from recharging, and therefore to have a higher charge level if by chance one of said electric vehicles i and i′ were to be prematurely disconnected from the electric vehicle charging station EVCS 122.

To enable the charging of a said electric vehicle EV1 151a, EV2 151b, the electric vehicle charging station EVCS 122, by means of the application and power-relay function APP+PR 171, closes a relay so as to electrically supply the phase P″ of the corresponding electrical connector 150a, 150b. For any electric vehicle EV1 151a, EV2 151b that does not have to be charged at that moment, the electric vehicle charging station EVCS 122, by means of the application and power-relay function APP+PR 171, opens the corresponding relay so as not to electrically supply the phase P″ of the corresponding electrical connector 150a, 150b.

FIG. 4 illustrates schematically an example of a hardware platform for implementing, in the form of electronic circuitry, the controller of the electric vehicle charging station EVCS 122.

The hardware platform comprises, connected by a communication bus 410: a processor or CPU (“Central Processing Unit”) 401; a random access memory RAM 402; a non-volatile memory 403, for example of the ROM (“read-only memory”) or EEPROM (“Electrically Erasable Programmable ROM”) type, such as a flash memory; a storage unit, such as a hard disk drive HDD 404, or a storage medium reader, such as an SD (“Secure Digital”) card reader; and a communication interface manager COM 405; and an input/output manager I/O 406.

The interface manager COM 405 enables the electric vehicle charging station EVCS 122 to interact with other equipment by means of the communication interfaces 176, 177.

The input/output manager I/O 406 enables the electric vehicle charging station EVCS 122 to open and close, selectively, relays for electrical supply to the electrical connectors 150a, 150b.

The processor 401 is capable of executing instructions that form a computer program and are loaded in the random access memory 402 from the read-only memory 403, from an external memory, from a storage medium (such as an SD card), or from a communication network. When the hardware platform is powered up, the processor 401 is capable of reading the aforementioned instructions from the random access memory 402 and executing them. When they are read (from the random access memory 402 or a storage medium) and executed by the processor 401, these instructions (which form a computer program) cause the execution, by the processor 401, of all or some of the steps, methods and operations described here.

All or some of the steps, methods and operations described here can thus be implemented in software form by executing a set of instructions by a programmable machine, for example a processor of the DSP (“digital signal processor”) type or a microcontroller, or be implemented in hardware form by a machine or a dedicated electronic component (“chip”) or a set of dedicated electronic components (“chipset”), for example an FPGA (“field-programmable gate array”) or an ASIC (“application-specific integrated circuit”) component. In general terms, the electric vehicle charging station EVCS 122 comprises electronic circuitry adapted and configured to implement the operations, methods and steps described here.

1. A method for managing charging of a plurality of electric vehicles implemented by an electric vehicle charging station connected downstream of a smart electricity meter, the electric vehicle charging station comprising:
an interface for communicating with the smart electricity meter;
an interface for communicating with the electric vehicles;
a man-machine interface;
the method being such that the electric vehicle charging station performs steps comprising:
obtaining, from the smart electricity meter, time ranges associated respectively with charging impact scores, each charging impact score representing an electricity-consumption impact during the time range in question;
identifying the electric vehicles connected;
interrogating the charge level and the charging current of the electric vehicles identified;
obtaining a user entry, via the man-machine interface, of a charging objective for each of the electric vehicles identified, the charging objective representing a charge level to be achieved at a target time;
obtaining a current time;
calculating a required total charging duration, for each electric vehicle identified, to achieve the charge level to be achieved and the charging current of the electric vehicle in question;
eliminating, for each electric vehicle identified, every time range that is inapplicable with regard to the current time and the target time for the electric vehicle in question;
calculating charging durations, for each electric vehicle identified, for each time range remaining, so as to minimise a total charging impact score for charging the electric vehicles identified to achieve the charging objectives;
controlling the charging of the electric vehicles according to a schedule defined by said charging duration calculations.

2. The method according to claim 1, wherein the electric vehicle charging station obtains information indicating whether simultaneous chargings are enabled or not, and said charging duration calculations, for each electric vehicle identified, for each remaining time range, take account of the information indicating whether simultaneous chargings are enabled or not.

3. The method according to claim 2, wherein the information indicating whether simultaneous chargings are enabled or not is obtained by user entry via the man-machine interface.

4. The method according to claim 2, wherein, when simultaneous chargings are enabled, the electric vehicle charging station performs the following steps:
calculating firstly the charging durations, for each time range and for each electric vehicle identified, avoiding the simultaneous charging of said electric vehicles;
if the charging objectives can thus be achieved, and if the resulting total charging impact score is suitable for the user, charging the electric vehicles without overlap of their charging period;
otherwise calculating the charging durations, for each time range and for each electric vehicle identified, enabling the simultaneous charging of said electric vehicles.

5. The method according to claim 2, wherein, for non-enabled simultaneous chargings, the electric vehicle charging station calculates the charging durations XiTj, for each electric vehicle i, and for each time range Tj, taking account of the fact that the sum of the charging durations XiTj, with i=1, . . . , n, for any j=1, . . . , m, does not exceed the duration DTj of the time range Tj in question, i.e.:
$${\sum }_{i = 1}^{n} XiTj \leq DTj ,$$
for any j=1, . . . , m by maximising the following expression, for each time range Tj, taking the time ranges in their increasing order of charging impact score STj:
$${\sum }_{i = 1}^{n} ( XiTj \times Ii )$$
with XiTj≤min (XiTjₘₐₓ; Di) without overlap of the charging periods,
where Ii represents the charging current of the electric vehicle i,
where XiTjₘₐₓ is the maximum charging duration for the electric vehicle i during the time range Tj, with XiTjₘₐₓ=0 for each time range that is inapplicable for the electric vehicle i, and if not XiTjₘₐₓ=min (Di; DTj) otherwise,
and where Di is said total charging duration required for the electric vehicle i.

6. The method according to claim 2, wherein, for non-enabled simultaneous chargings, the electric vehicle charging station calculates the charging durations XiTj, for each electric vehicle i, and for each time range Tj, taking account of the fact that the sum of the charging durations XiTj, with i=1, . . . , n, for any j=1, . . . , m, does not exceed the duration DTj of the time range Tj in question, i.e.:
$${\sum }_{i = 1}^{n} XiTj \leq DTj ,$$
for any j=1, . . . , m by maximising the following expression, for each time range Tj, taking the time ranges in their increasing order of charging impact score STj:
$${\sum }_{i = 1}^{n} ( XiTj \times Ii )$$
with XiTj≤min (XiTjₘₐₓDi) without overlap of the charging periods,
where Ii represents the charging current of the electric vehicle i,
where XiTjₘₐₓ is the maximum charging duration for the electric vehicle i during the time range Tj, with XiTjₘₐₓ=0 for each time range that is inapplicable for the electric vehicle i, and if not XiTjₘₐₓ=min (Di, DTj) otherwise,
where DTj is the duration of the time range Tj and Di is said total charging duration required for the electric vehicle i,
and where DTj_i is the maximum duration in the time range Tj during which the electric vehicle i can be charged.

7. The method according to claim 2, wherein, for enabled simultaneous chargings, the electric vehicle charging station calculates the charging durations XiTj, for each electric vehicle i, so that
$$XiTj = min ( {XiTj}_{max} D i - {\sum }_{k ∖ STk < STj} XiTk )$$
where XiTjₘₐₓ is the maximum charging duration for the electric vehicle i during the time range Tj, with XiTjₘₐₓ=0 for each time range that is inapplicable for the electric vehicle i, and if not XiTjₘₐₓ=min (Di; DTj) otherwise,
where DTj is the duration of the time range Tj and Di is said total charging duration required for the electric vehicle i,
and where k \ STk<STj signifies k such that STk<STj, where STj represents the charging impact score associated with the time range Tj.

8. The method according to claim 2, wherein, for enabled simultaneous chargings, the electric vehicle charging station calculates the charging durations XiTj, for each electric vehicle i, so that
$$XiTj = min ( {XiTj}_{max} D i - {\sum }_{k ∖ STk < STj} XiTk )$$
where XiTjₘₐₓ is the maximum charging duration for the electric vehicle i during the time range Tj, with XiTjₘₐₓ=0 for each time range that is inapplicable for the electric vehicle i, and if not XiTjₘₐₓ=min (Di, DTj) otherwise,
where Di is said total charging duration required for the electric vehicle i,
where DTj_i is the maximum duration in the time range Tj during which the electric vehicle i can be charged,
and where k \ STk<STj signifies k such that STK<STj, where STj represents the charging impact score associated with the time range Tj.

9. The method according to claim 1, wherein, the electric vehicle charging station comprising a shunt on each phase intended to electrically supply an electrical connector to which a said electric vehicle is connected, the electric vehicle charging station ensures, by measuring electrical consumption by means of the shunt, that the charging of the electric vehicle concerned is actually under way when charging is required and gives a user alarm in the contrary case.

10. (canceled)

11. A non-transitory storage medium, storing a computer program product comprising instructions causing the execution, by a processor, of the method according to claim 1, when said instructions are read from the storage medium and executed by the processor.

12. An electric vehicle charging station that is configured to charge a plurality of electric vehicles and is intended to be connected downstream of a smart electricity meter, the electric vehicle charging station comprising:
an interface for communicating with the smart electricity meter;
an interface for communicating with the electric vehicles;
a man-machine interface; and
electronic circuitry configured to perform steps comprising:
obtaining, from the smart electricity meter, time ranges associated respectively with charging impact scores, each charging impact score representing an electricity-consumption impact during the time range in question;
identifying the electric vehicles connected;
interrogating the charge level and the charging current of the electric vehicles identified;
obtaining a user entry, via the man-machine interface, of a charging objective for each of the electric vehicles identified, the charging objective representing a charge level to be achieved at a target time;
obtaining a current time;
calculating a required total charging duration, for each electric vehicle identified, to achieve the charge level to be achieved and the charging current of the electric vehicle in question;
eliminating, for each electric vehicle identified, every time range that is inapplicable with regard to the current time and the target time for the electric vehicle in question;
calculating charging durations, for each electric vehicle identified, for each time range remaining, so as to minimise a total charging impact score for charging the electric vehicles identified to achieve the charging objectives;
controlling the charging of the electric vehicles according to a schedule defined by said charging duration calculations.
